(19) United States
(12) Patent Application Publication
(10) Pub. No.: US 2015/0098217 A1
(43) Pub. Date: Apr. 9, 2015

(54) Color Blending System and Method

(71) Applicant: Deran Stinson Eaton, Waldorf, MD (US)

(72) Inventor: Deran Stinson Eaton, Waldorf, MD (US)

(21) Appl. No.: 14/046,278

(22) Filed: Oct. 4, 2013

(51) Int. Cl. F21K 99/00

(52) U.S. Cl. CPC F21K 9/54
USPC 362/231

(57) ABSTRACT

The invention features a color blending system and method to provide color blending. The optical assembly features a fixture base having a four-layer printed circuit assembly hosting all LED drivers, power conditioning and switched signal distribution for the fixture. The printed circuit assembly also hosts an array of connectors that accept modular LED shims whereby all light will emit outward at 30-degree radial increments around the semicircle area of the fixture roughly parallel to the plane of the printed circuit assembly in a blended fashion. The system features an integral heat sink and diffuser fingers which reflect and transmit light. Color combinations vary based on positioning of the fixtures in relation to each other.

### FIELD OF THE INVENTION

The present invention relates, in general, to a color blending system and method, and more specifically a method and system having an adaptive optical assembly to provide color blending.

### BACKGROUND OF THE INVENTION

Lighting affects ones mood and can also transform a room. Types of lighting designs include ambient lighting, task lighting, accent lighting, and decorative lighting. Decorative lighting can be the centerpiece or focal point of a room. Lighting systems typically emit a single color. Color blending mixes two colors together to produce a third color to provide decorative lighting but current systems are expensive and require professional installation and expertise to set-up.

### SUMMARY OF THE INVENTION

The present invention provides a fixture having and optical assembly featuring diffuser fingers which reflect and transmit light, half cylinder mirrors, heat dissipation mechanisms and illuminating sources which display in a color blending fashion.

An aspect of an embodiment of the invention provides a design having a maximum LED electrical load that prevents overload conditions.

A further aspect of an embodiment of the invention features illuminating elements fully separable from the driver circuits.

A further aspect of an embodiment of the invention features an alignment of diffuser fingers.

A further aspect of an embodiment of the invention features using the illuminating elements through LED lead holes to dissipate heat.

A further aspect of an embodiment of the invention features fully addressable control over light color selection and intensity depending on the installed wiring options.

Additional aspects, objectives, features and advantages of the present invention will become apparent from the following description of the preferred embodiments with reference to the attached drawings.

### BRIEF DESCRIPTION OF THE DRAWINGS

FIG. 1 is an illustration of the electrical power scheme of the lighting system.

FIG. 2 is an illustration of the adaptive LED fixture base.

FIG. 3 is an illustration of LED Shim Assembly and LEDs.

FIG. 4 is an illustration of the Liberty Crown LED Fixture Layout.

FIG. 5 is an illustration of the Revelation Cross LED Fixture Layout.

FIG. 6a is an illustration of the Optomechanical Assembly Method.

FIG. 6b is an illustration of the optomechanical assembly with straps securing the spokes of the present invention.

FIG. 7a is an illustration of the strip of the present invention.

FIG. 7b is an illustration of the Transflective Diffuser Facet.

FIG. 7c illustrates beam traces of LEDs projecting through the transflective diffuser facet.

FIG. 8a is an exploded, view of the lighting system.

FIG. 8b is an illustration of the lighting system assembled.

FIG. 9a is an illustration of the Liberty Crown illumination pattern and neighboring Liberty Crown demonstrating the blending of colors.

FIG. 9b is an illustration of the neighboring Liberty Crown illumination pattern.

FIG. 10 is an illustration of the Revelation Cross Illumination Pattern.

FIG. 11a is an illustration of two fixture bases with the circular areas facing each other, collectively the “XX Hourglass”.

FIG. 11b is an illustration of the straight edges of two fixture bases facing each other where one connector on each base is aligned collectively the “Figure Eighter”.

FIG. 11c is an illustration of the straight edges of two fixture bases facing each other, collectively the “Oval Rainbow”.

FIG. 11d is an illustration of the straight edges of two fixture bases facing each other with LED shims attached, collectively the “Stretched Column”.

FIG. 12a illustrates three fixture bases aligned to form a triangular radiance pattern, having a multiple LED, right angled shim set shining vertically from center, collectively the “Triangulator 15.”

FIG. 12b illustrates three fixture bases aligned to form a triangular radiance pattern, having a single high power LED right angle shim set shining vertically from center, collectively the “Triangulator 3.”

FIG. 12c illustrates four fixture bases aligned to collectively generate a “Full Shamrock”.

FIG. 13a illustrates three fixture bases aligned as an inverted triangle, with corner crossover optical blending, collectively forming the “Triad Spikes”.

FIG. 13b illustrates three fixture bases aligned and inverted, having a combination multicolor and high power LED right angle shim set radiating out of the fixture base plane, collectively forming the “Triad Plane Fill.”

FIG. 14a illustrates four fixture bases aligned to form the “Squared Out” assembly. FIG. 14b illustrates four fixture bases aligned to radiate a full square cross, having corner crossover optical blending, collectively forming the “Squared In” assembly.

FIG. 15a illustrates a first LED ray trace.

FIG. 15b illustrates a second LED ray trace.

FIG. 15c illustrates a third LED ray trace.

FIG. 15d illustrates a fourth LED ray trace.

FIG. 15e illustrates a fifth LED ray trace.

### DETAILED DESCRIPTION OF THE INVENTION

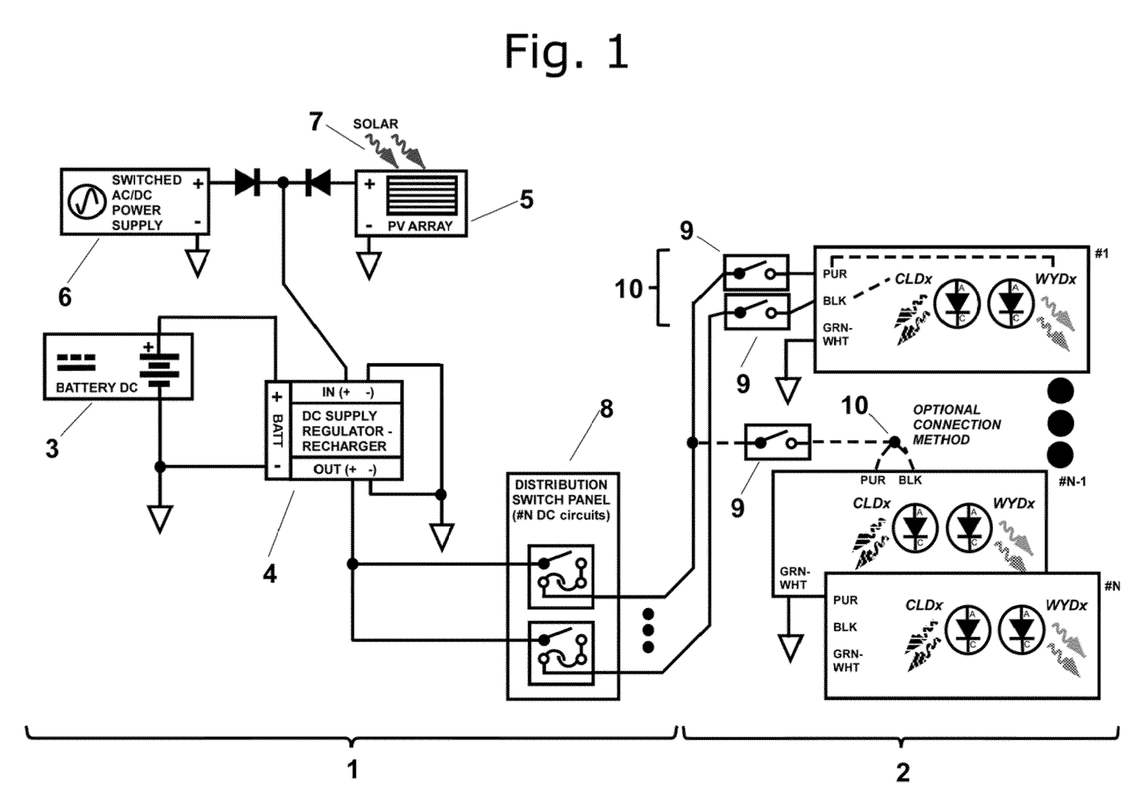

FIG. 1 illustrates the electrical power scheme of the lighting system 2. The system is compliant with the National Electrical Code (NEC) 2008 Edition Article 411 requirements for low voltage lighting systems, preferably sourced from an NEC 2008 Article 690-compliant renewable energy system. As built, the system features a building-integrated DC power distribution system (1) dedicated for the Adaptive LED luminaire lighting system (2) operation. The typical power source is a ±12 VDC battery bank (3) of minimum 7.5 amp-hour capacity, controlled by a source selecting power regulator (4). The battery bank is recharged either by a small, roof-integrated photovoltaic array (5), or a dedicated AC/DC +24 V. 6.5 A switching power supply (6) sourced by one of the 120 VAC power circuits where the systems are installed.

Preferably, a solar recharge (7) keeps the battery bank (3) energized. allowing the AC DC supply (6) to remain off depending on the system's duty cycle and switched-in load. Nominally, each Adaptive LED Luminaire (2) can accept between +7 and +24 VDC, drawing at most five watts each. An exclusively 120 VAC circuit can also energize the Adaptive LED Luminaires by employing AC/DC conversion circuitry in the fixture apart from the luminous elements.

While the plenary DC electrical distribution panel (8) features circuits and switches. The DC power distribution system is made up of the battery (3), rechargeable system (7), regulator (4), power supply (6) and the DC electrical distribution panel (8).

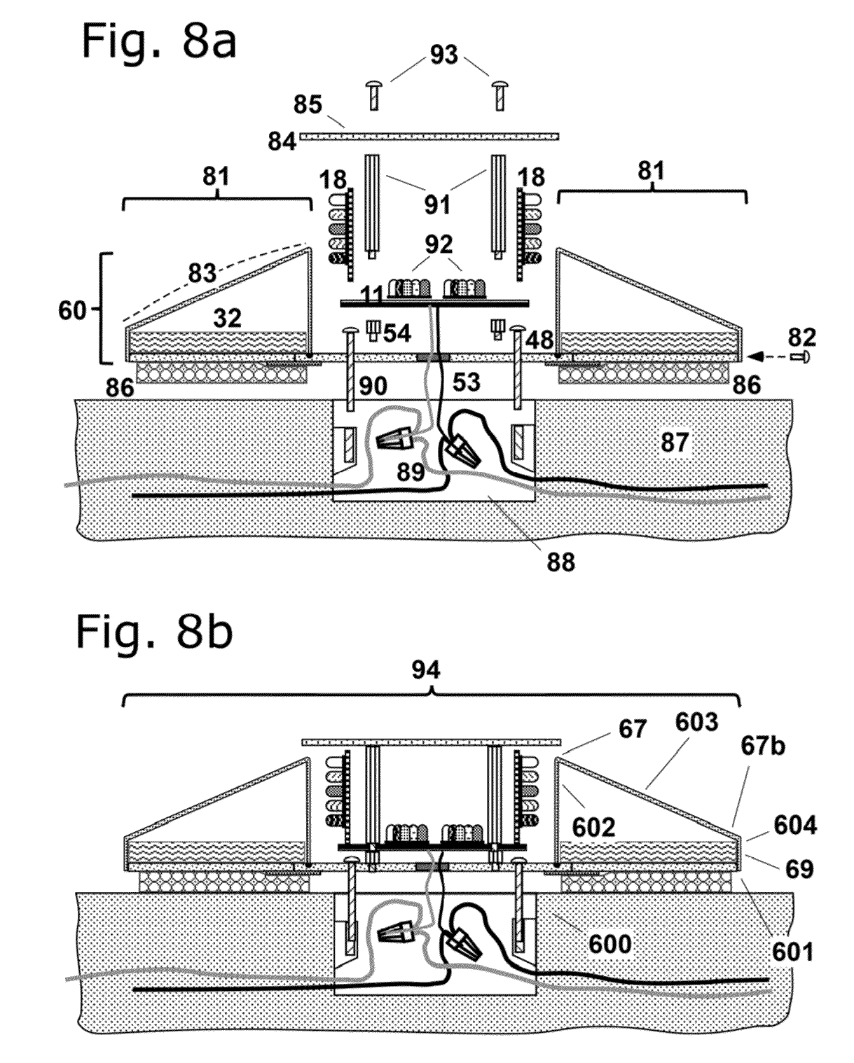

The fixture, as shown in FIG. 8b is designed as a “wallwashing,” sconce-type lighting system using regular 120 VAC-rated ON/OFF switches (9) such that the system produces a relatively smooth, even level of illumination on a wall that minimizes the apparent texture of the surface. The system does not require remote control systems; however, a remote control may be added to control the system. The system installable with minimum electrical trades talent—e.g., a journeyman's skill. Automation reduction also makes for easier system understanding and operation among a variety of people, while permitting fully addressable control over light color selection and intensity depending on the installed wiring options (10). DC supply operation renders the Adaptive. LED Luminaire System immediately connectable to renewable energy DC sources without the expense and power losses from DC/AC inverters.

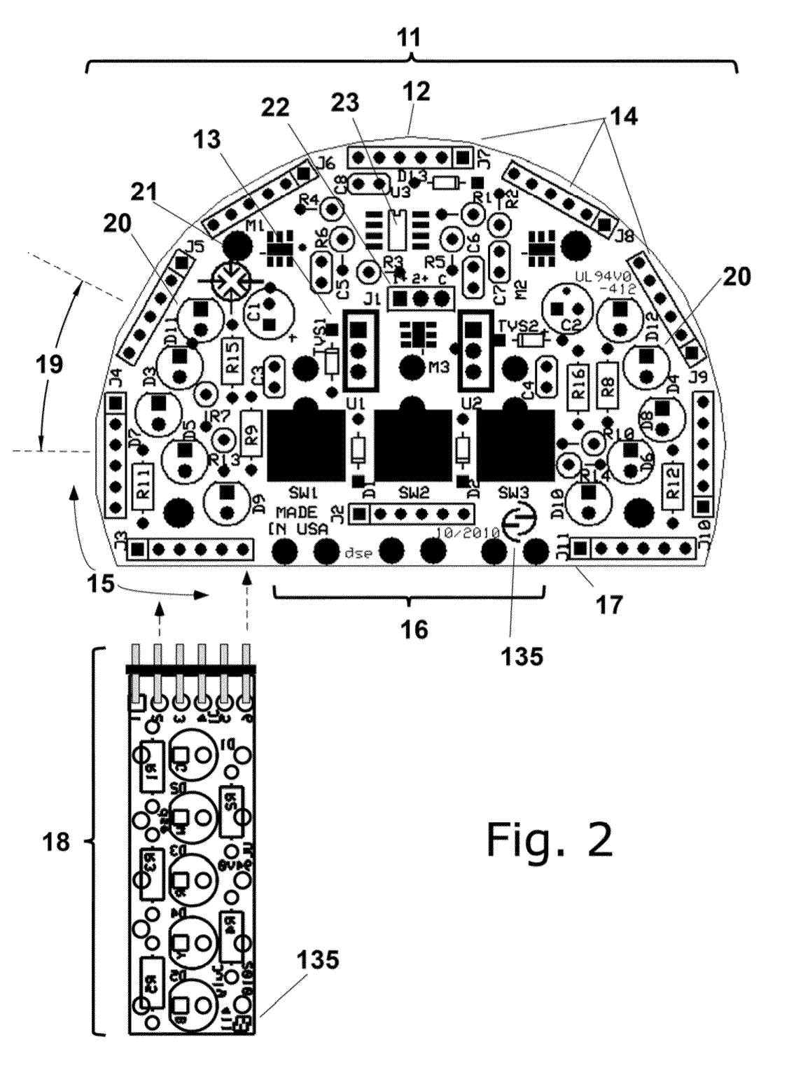

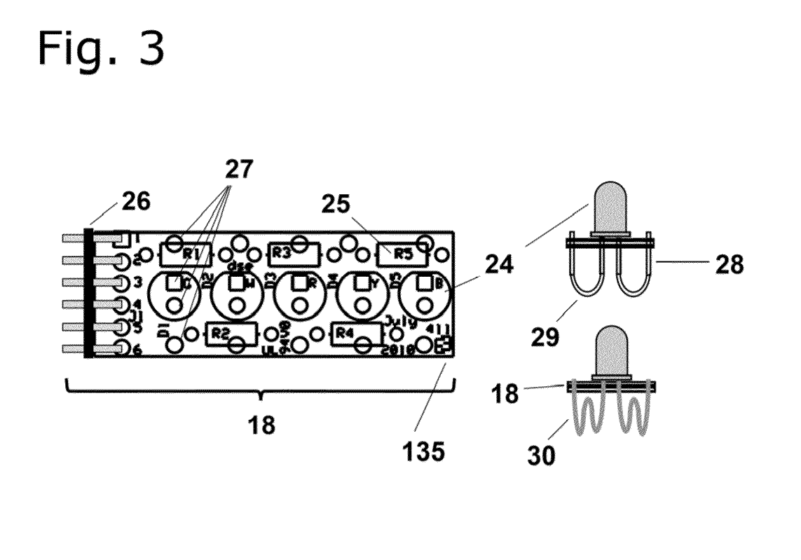

FIG. 2 illustrates the adaptive LED fixture base (11). The fixture base (11) is an FR-4 four-layer printed circuit assembly (12) hosting all LED drivers, power conditioning and switched signal distributions for the fixture. The base (11) also supports an array of connectors (14) that accept modular LED shims (18 also shown in FIG. 3). The lights will project or shine outwards at 30-degree radial increments (19) around the semicircle, and below the flat edge, as selectively populated; roughly parallel to the plane of the printed circuit assembly (12). The Adaptive LED Fixture Base layout centers DC power input regulator and modulator circuits (13) within a semicircular array of 1×6 single inline package (SIP) connector sockets (14), which accept a matching 1×6 pin plug at 0.100-in pitch. The sockets (14) are positioned along the fixture base periphery (15) to aim LED lights outward.

Three SPST latching pushbutton switch positions (16) overlay socket positions on the squared off side (17) of the base (11). Two LED “activity mirror” clusters (20) flank the switch positions, indicating which circuits are active as well as illuminating the fixture cover optic (FIGS. 8a, 84,85). Four #6-sized mounting holes (21) provide the anchor points to the fixture optics. All illuminating devices on the Adaptive LED Fixture Base are through-hole LED devices. Basic Fixture Base dimensions are 3″ L×2″ W (metric; 76.2 mm L×50.8 mm H), though this may vary with scale provided the semicircular shim connection arrangement (14, 19) is retained.

The power input regulator circuit input from two separate, positive DC feeds referenced to a common return (22); effectively making the Adaptive LED Fixture Base two lights in one provided external wiring takes advantage of this feature. When either feed is active, any DC input voltage between +7 and +24 VDC is regulated to +5 VDC at 1.5 A maximum current per feed. Actual load, however, is dictated by LED population in the shim solution and how many lighting output circuits are active at the time. This means the Adaptive LED Fixture Base can operate at 20%, 40%, 60%, 80%, or full capacity, a switching feature that truly reduces effective load proportional to active lighting.

The modulator circuit (23) operates nominally as a quadrature sine wave oscillator at 400 Hz over a 0-5 V amplitude, centered at: a 2.5 V offset, The sine and cosine outputs respectively feed NFET gates, which in turn source oscillated power to the Adaptive LED Fixture Base's present LED solution, This modulation ensures a smooth signal transition driving the LEDs; plus, with the LED current limited to 80% of maximum rating by resistor selection. the LEDs useful life is extended while still delivering useful light. Typical current draw for most LED selections ranges from 7 mA-20 mA for LEDs operating below +5 VDC.

At each connector (14), where desired, is a 5-element LED Shim Assembly (18). The present Fixture Base embodiment can accommodate seven LED Shims with switches SW1-SW3 (16) mounted and up to 10 LED Shims with switches SW1-SW3 uninstalled and their contacts shorted.

FIG. 3 illustrates LED Shim Assembly (18) and LEDs (24). An LED Shim (18) employs through hole LEDs (24) and current limiting resistors (25) of common variety, with component selection biased to high luminosity per unit of power with a moderate +/−30 to 45 degree FWHM directionality. Colors in the present LED Shim embodiment (bottom to top) are Green, White, Red, Yellow and Blue. A 1×6 0.100-in pitch male plug connector (26) attaches the LED Shim (18) to a Fixture Base socket (14). The LED Shim (18) is a basic rectangular. 1- to 2-layer FR-4 circuit card. assembly with a 1×6 single inline male connector, occupying a volume defined 1.875″ L×0.75″ W×0.625″ H (metric: 47.63 mm L×19.05 mm W×15.88 mm H. with H-dimension variance allowed for selected LED height. Each of the five pins receives a separate LED with the sixth pin providing a common return. To mitigate LED heat without: extra heat sinks, and to reduce assembly waste, during the LEI) insertion process, an opposing guide curls or buckles the through hole LEDs' leads (28) into a wound (29) or criss-cross (30) radiator through the additional holes. This is then squeezed and soldered into place. The heat sink assembly is formed from the LED electrical connections' excess length, without their discard as waste. The curl insertion process was can be performed manually using, needle nose pliers, for example. However, the insertion may be duplicated using automated assembly schemes without the waste of lead trimmings. This assembly method does not affect the LEDs electrically. Optically, this method adds some light mixing patterns to Fixture Base-mounted LEDs if an LED Shim is installed above a Base “activity mirror” LED Cluster. The number of color combinations an LED Shim (18) may yield is given by 2^{N}−1, where ‘N’ is the number of distinct colors an LED Shim hosts. Because of this binary progression, switched controls may be implemented via simple switches or digital electronics. Simple switching governs the current embodiment. Other LED Shim embodiments may employ variants according to designer tastes, circuitry scaling and available LED technology provided the interfacing paradigm remains consistent.

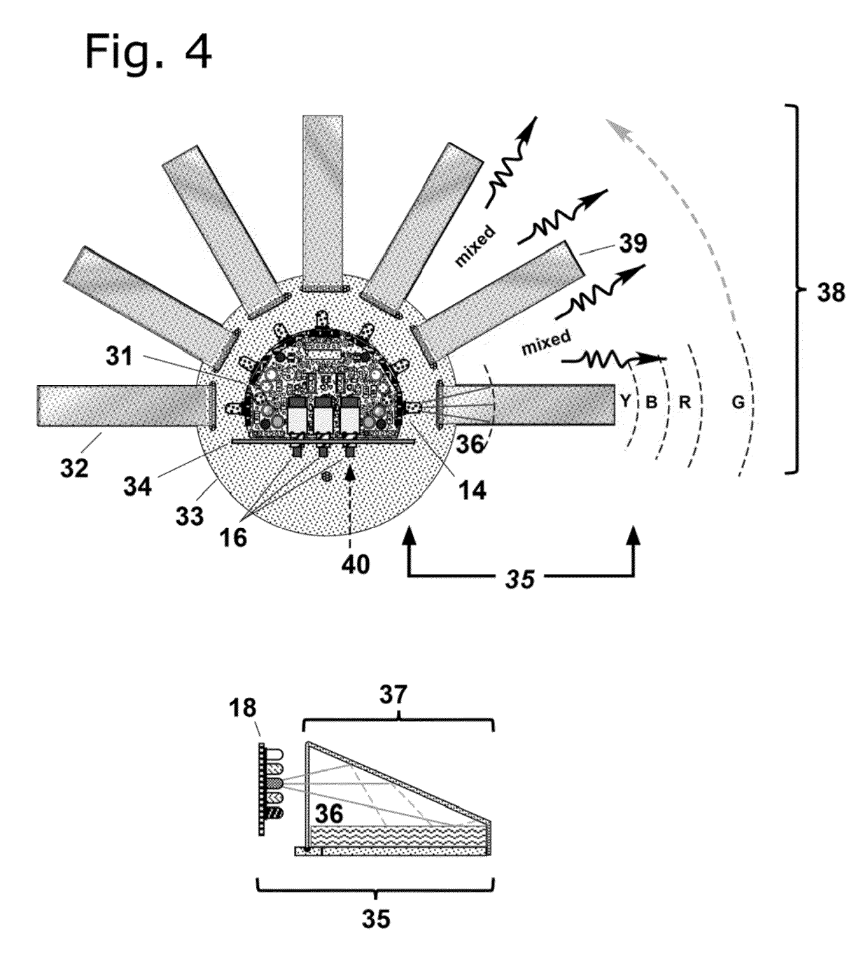

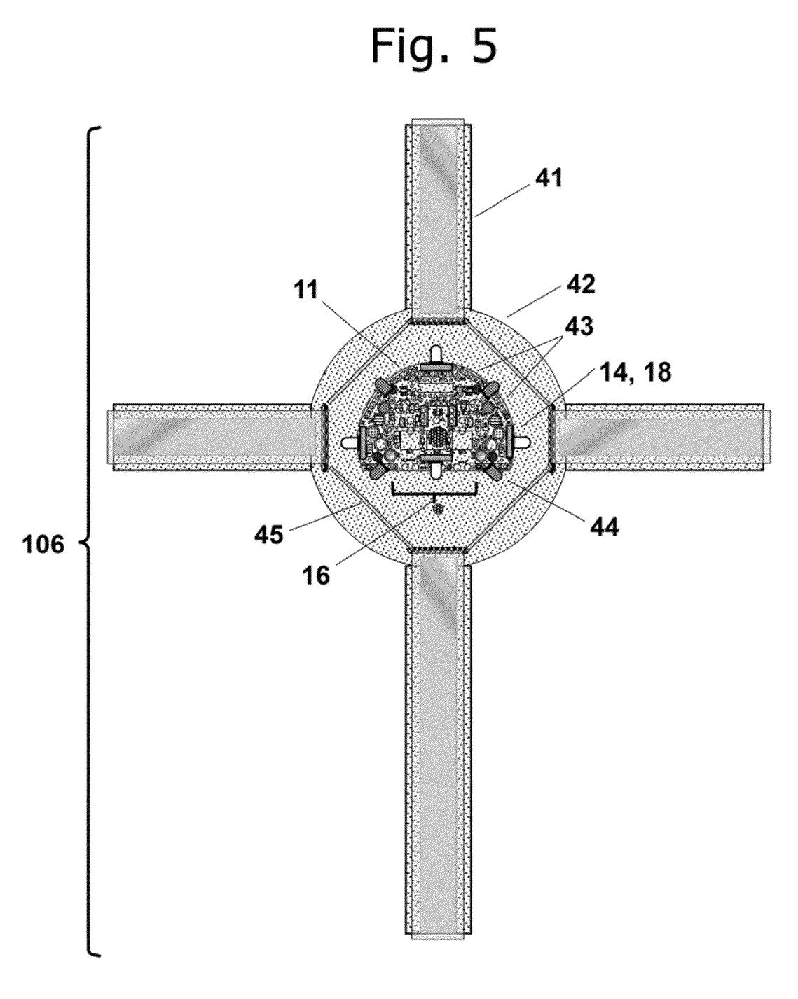

With the Fixture Base and LED Shims prepared, any kind of Host Fixture Optics may be designed around the Adaptive Fixture Base, accommodating the LED Shim height plus mounting standoffs when plugged in. In this sense, the current embodiment's Host Fixture Optics is a “polymorphic” systemic design paradigm, since many types of LED fixtures can he designed and assembled around the same Fixture Base, depending on the parts selections chosen to populate the Fixture Base from a common design method. Though any implementations are possible, FIGS. 4 and 5 demonstrate the Adaptive LED Luminaire System's optical polymorphism with two types of optomechanical fixtures: A “Statue of Liberty Crown” (FIG. 4) and a “Revelation Cross” (FIG. 5). FIG. 4 illustrates the Liberty Crown LED Fixture Layout. FIG. 5 illustrates the Revelation Cross LED Fixture Layout.

Regarding FIG. 4, Liberty Crown features seven spokes (32, typical) radiating outward from a round disc (33), The spokes are spatially matched to correspond with the seven LED Shim connectors (14) mounted only on the semicircular portion (31) of the Adaptive Fixture Base circuit card perimeter. Switch positions SW1-SW3 (16) are populated normally, attached to a 1/16-inch clear polycarbonate cover plate (34), with all other circuitry installed as previously described. Configured in this manner, when viewed from the side (35), the enabled switch combination tailors the Adaptive LED Luminaire's active color output (36), from each LED Shim (18) through a transflective diffuser “finger” (37), which receives and transmits light, without changing out any bulbs or changing the fixture. The three-switch combination circuit with the fixed two-color combined circuit yields up to 15 different light combinations and intensities with no changes to Adaptive Fixture hardware other than working the switches. The fully active result is a selectable, wall washing “rainbow beam effect” (38) extending out symmetrically side-to-side and out each fingertip (39). Color switch actuation (40) is achieved using any type of narrow poking device available such as a yard/meter stick, broom or mop handle, golf club handle, human fingers, for example. Although, the system can be designed to actuate via remote.

Regarding FIG. 5, the Revelation Cross (107), by contrast, consists of four spokes (41) radiating outwards from around disc (42), with the southern spoke being nearly twice the length of the other three. The spokes on this model are also wider. On the Adaptive Fixture Base (11), the four opposing connector positions (14) only receive LED Shims (18), again positioned to shine down the length of the spokes. By necessity, this forces omitting switch position SW2 to accommodate an LED Shim connector across it. In the present invention, all Switch positions SW1-SW3 (16) are omitted, with their connections shorted ON. With all other circuits installed normally, this yields strict ON/OFF operation for all LED's on each of the Adaptive Fixture Base's drive circuits, but the electrical form factor has remained largely unchanged.

Unpopulated LED Shim positions (43) on the Adaptive Fixture Base (11) accommodate single “flanking” LED installations (44) as accents to the main illumination. Green “flanking” LEDs accent the current Revelation Cross embodiment. Four clear polycarbonate panels (45) surround the populated Adaptive Fixture Base (11).

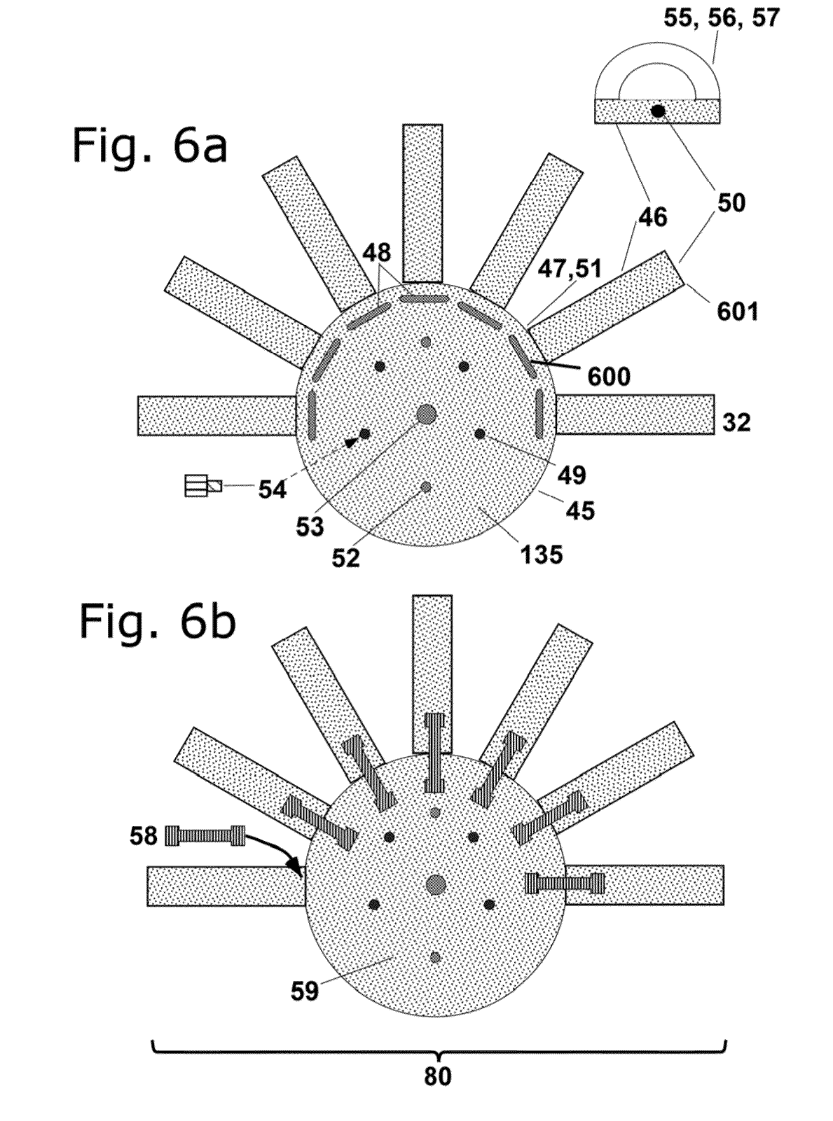

FIG. 6a illustrates the Optomechanical Assembly Method. FIG. 6b illustrates the optomechanical assembly with straps securing the spokes of the present invention For discussion purposes, the Liberty Crown design is discussed however, the same process fundamentally to applies to all other variations. To reduce waste, the process instantiates numerous simple shapes of various non-conductive materials, then fashions and fastens them into a fused optical unit. The process begins by cutting the circular sconce base (45) as basic, white polyvinyl chloride (PVC) shapes from 0.25″ T (6.35 mm T) sheet stock, Each spoke (32) begins as a rectangle (46), slightly trimmed to match the disc curve (47), with optics mounting grooves (48) and fastener holes (49) inserted. Each rectangle tip also receives a smaller mounting hole (50) for later setting the transflective diffuser into place Checking alignment with an Adaptive Fixture Base circuit card (11), each spoke is fused to the disc using PVC pipe cement (51). Once cured, fixture anchoring (52) and wire passthrough holes (53) are drilled, with fastener holes (49) tapped for 46-32 threads, Nylon 0.25 #6-32 M-F standoffs (54) are then inserted. Semicircular mirror (55) fashioned from a ½″ trade size Schedule 40

PVC conduit bisected lengthwise (56) and chronic paint (57) is then adhered atop the length of each spoke, extending to the corresponding optic mounting groove, and clamped tight until cured. Chrome paint (57) is silver, chrome or a similar reflective color. As shown in FIG. 6b, thin. PVC tie straps (58) are then adhered to the base bottom (59) and clamped until cured. This completes the foundation.

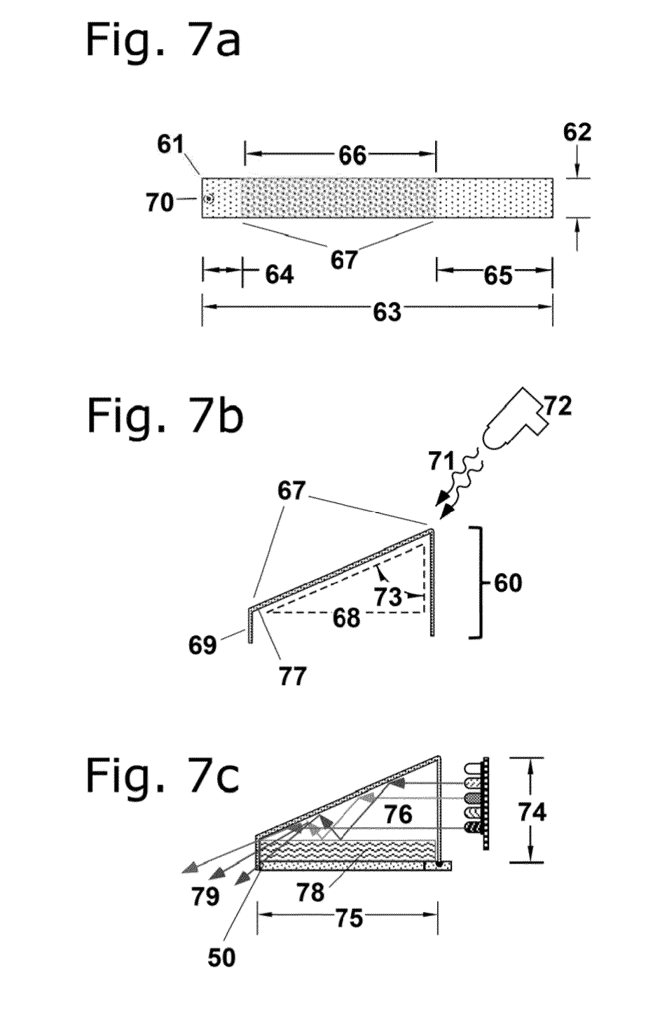

FIG. 7a illustrates the strip which forms the transflective diffuser facet of the present invention. FIG. 7b illustrates the Transflective Diffuser Facet. Each Adaptive Fixture Base spoke features a transflective diffuser facet (TDF) made from 0.062″ T (1.58 mm T) clear polycarbonate such as Lexan, Makrolon GP, for example. Each TDF (60) is fashioned from a single clear polycarbonate strip (61) of uniform width (62), sized to match the spoke it mounts over. Cut length (63) is the sum of the end spoke height (64), plus the height (65) of the Adaptive LED Fixture Base (with Shims), plus 0.25″ working clearance, plus the hypotenuse length of the triangle formed by the slope (66) from the LED Shim top to end spoke mirror top. The two top points just mentioned are also the bend points (67) that form the stated triangular shape (68). The diffuser surface (69) is applied using 220-grit sandpaper huffed into the outward facing surface between both top points (67), which are scored lightly across the strip width at the diffusion boundaries. The remaining short clear side (69) receives a countersunk mounting hole (or other fastening method, 70) matched to the foundation spoke's outside end hole (50). The surface (69) is a hermetically set corner with bends +/−5 degrees of a nominal angle and will impart an outward bend across the transflective diffuser surfaces. This will concentrate light towards the center of each finger and addes to z-vector reflection, wasted light.

Spokes' first end 600 is attached to the fixture in a radial fashion, as shown in FIG. 6a and 6b. The spoke's second end 601 is opposite the first end and does not touch the fixture surface but sits in a floating fashion from the fixture. As shown in FIG. 8b, the strip 61 features a first leg 602 which extends upwards from the first end 600 to a first point 67a and is then angled to extend towards the second end 601 to a second point 67b to form a hypotenuse 603. The second point 67b is the right top surface 604 of the mirror. A hermetic seal 69 extends downward from the second point 67ba and the second end of the strip 601, which seals the strip onto the spoke. The facet shape is asserted by applying dry heat (71), such as from a hot air gun (72), and bend forming the polycarbonate strip at the scoring marks around a square forming block to the computed angles (73). Because the populated and mounted Adaptive Fixture Base height is consistent among designs, computed TDF bend angles (73) depend mostly upon the ratio of LED Shim height (74) to the spoke length (75).

FIG. 7c illustrates beam traces of LEDs, depicted by arrows, projecting through the transflective diffuser facet. Each TDF accepts LED light (76) for mixing transmission down the interior facet face (77) and out the spoke end (resulting in an endpoint “rainbow” effect), reflection off the spoke mirror (78) to flank the spoke and splay over the fixture mounting surface), and diffusely mix (79) all active colors within the TDF (60) itself

FIG. 8a is an exploded view of the lighting system assembly. FIG. 8b illustrates the lighting system assembled. Regarding FIG. 8a, the Optical Host Assembly (81) is complete once each individual TDF (60) affixes into the fixture base foundation (80), ordinarily over each spoke (32). The TDF (60) is adhesive braced between the mounting slot (48) and an end spoke fastener (82). This imparts a slight outward curve (83) to each TDF hypotenuse, extending both reflection and diffusion optics actions down the spoke length. At this time, a simple shape diffusion cap (84) is fashioned from more clear polycarbonate, with its full top side (85) uniformly buffed using 220-grit sandpaper. Half-inch thick adhesive foam weatherstrip (86) affixes to the bottom of each spoke (32), and around the foundation's outer perimeter, to cushion the lumenaire, seal insulation leakage and adjust: the lumenaire's optical distribution upon the host wall (87). Once all adhesive has cured, and #6-32 short M-F nylon standoffs (54) are inserted into the fixture base foundation (80), the Optical Host Assembly (81) is ready for mounting. The Adaptive Fixture Base (11) is installed and fully connected to the host wall wiring during Optical Host Assembly (81) mounting. The host fixture (88) and wiring (89) are presumed to be preinstalled according to National Electrical Code requirements suitable for the location, set in place using, a pair of #8-32 or #10-32×2-inch panhead machine bolts (90) typical of box fixture mounts, and wire nuts (91) to connect electrical power through the center hole (53). All bolts (90) are tightened down, with the Adaptive Fixture Base (11) held by #6-32×2-inch nylon hex standoffs (91) matched “1:1” to the short standoffs (54). The LED Shims (18) are now installed, pointing the LEDs to shine outward while the Adaptive Fixture Base's LEDs (92) shine upward. The diffuser cap (84) in turn screws down to the long standoffs using #6-32×38-inch panhead screws (93), completing one Adaptive LED Fixture (94), as shown in FIG. 8b. All final assembly variants surround the fixture base and LED Shim electronics with clear, durable, insulating polycarbonate, allowing multiple gaps between spokes and LED Shim for heat egress. This makes the fixture very durable, while imparting an artistic crystalline appearance when turned off.

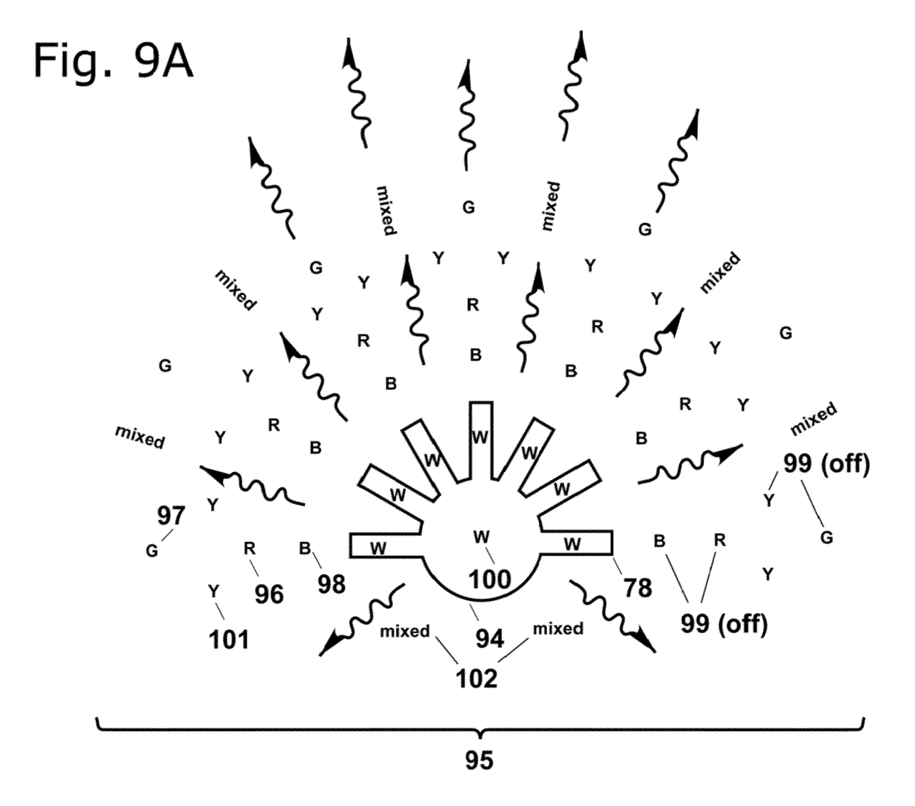

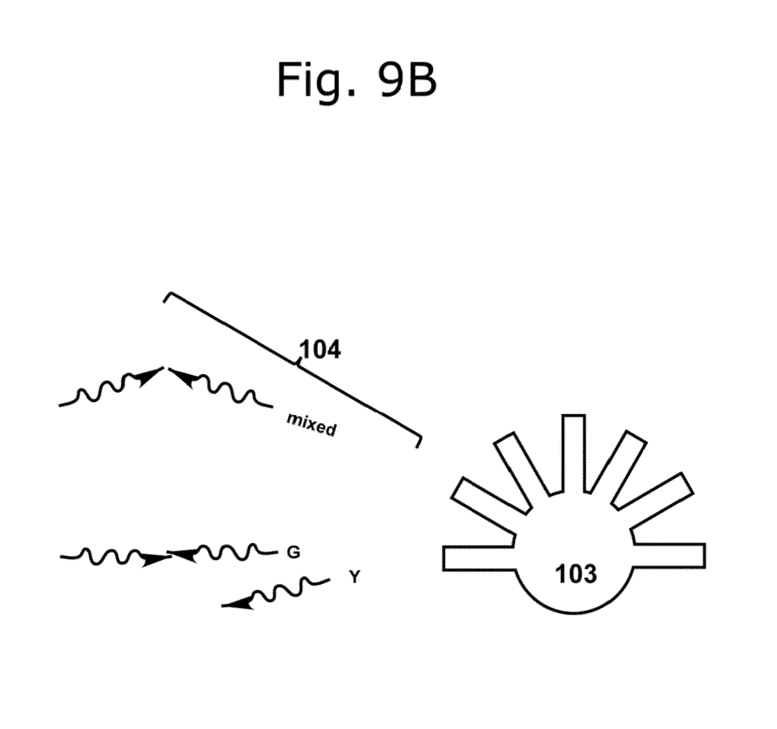

FIGS. 9A and 9B together illustrate the Liberty Crown illumination pattern (FIG. 9A) and its cascaded color blending with a neighboring Liberty Crown illumination pattern (FIG. 9B). The light distribution patterns remain consistent for all possible color selections discussed in previous figures. However, combination white light and rainbow effects yield their best result at maximum output. FIGS. 9A and 9B together illustrate the extensive illumination spread oldie nominally 31 possible color combinations the Liberty Crown package can produce from a common fixture, using, an LED Shim (18) populated using five distinct LED colors. Full output (95) resembles an exploding rainbow, per the optical spread pattern and mixing (38) shown in FIG. 4. Liberty Crown monocolor examples are also presented here in red (96, typical “R”), green (97, typical “G”), and blue (98, typical “B”). Of note, in any reduced output mode the spoke mirror (78) fingers produce a visible fingertip shadow (99) for each color switched off, White (100, typical “W”) and yellow (101, typical “Y”) are used together as the yellow softens the white when mixed. Color mixing (102) occurs throughout and around the Fixture. Finger shadows (99) get filled with each color added to produce subsequent color patterns. With other Liberty Crown fixtures spaced on the same level, each neighboring fixture (103) ray outputs will blend with each other symmetrically (104), creating a ‘light linking’ effect. Altogether, whichever lighting scheme is chosen, this system is capable of changing a room's decor with the flick of a switch. In FIGS. 9a and 9b, all colors are on.

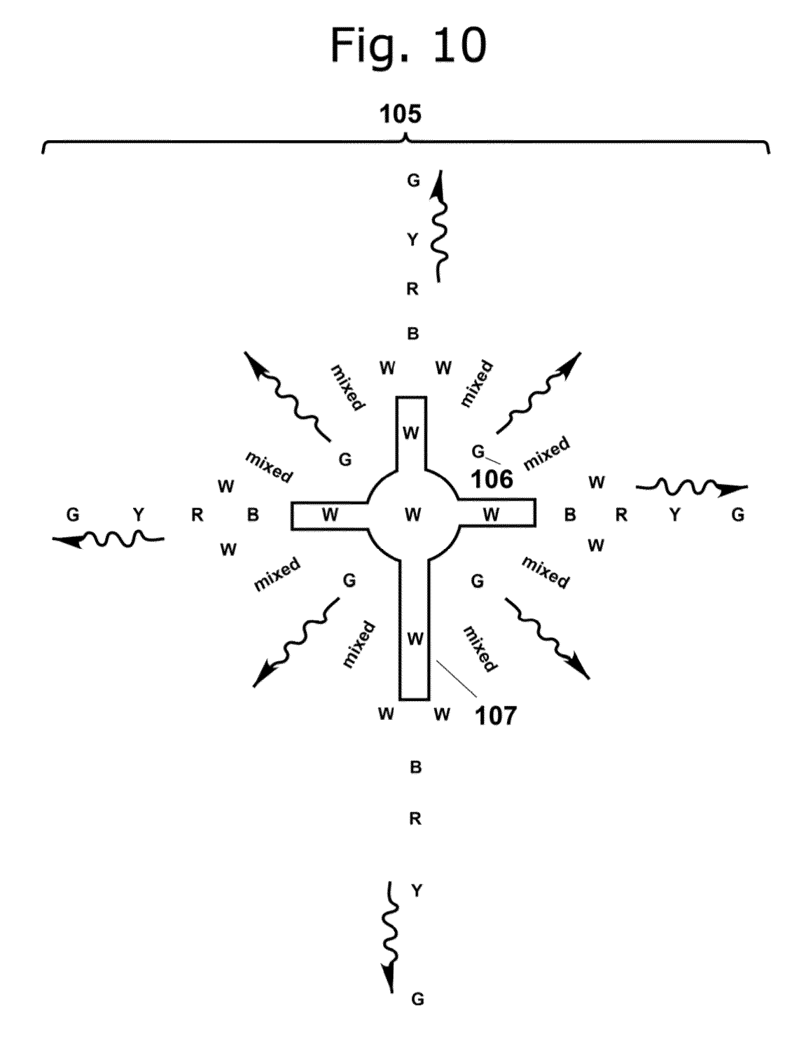

FIG. 10 illustrates the Revelation Cross Illumination Pattern. FIG. 10 reveals the Revelation Cross (107) embodiment's light output (105), which is hard wired during assembly to employ all circuits, four LED Shims, and four green accent LEDs at maximum output, as previously described in FIG. 5. Except for the dedicated green output (106) on NW, NE, SW and SE directions, the optical spread resembles the Liberty Crown fingered dispersion. The spread patterns on both embodiments extend out at: least 36 inches in “wall washing” illumination, mixing into well-ordered white light and rainbow patterns not found in typical “wall washing” lighting fixtures. Each major lumeniere component (Base, Host Fixture, LED Shim) may be personalized with a unique design such as a logo, symbol, design or the like. FIGS. 2, 3 and 6 indicate typical imprint placements 135, either as etchings or part of a service label.

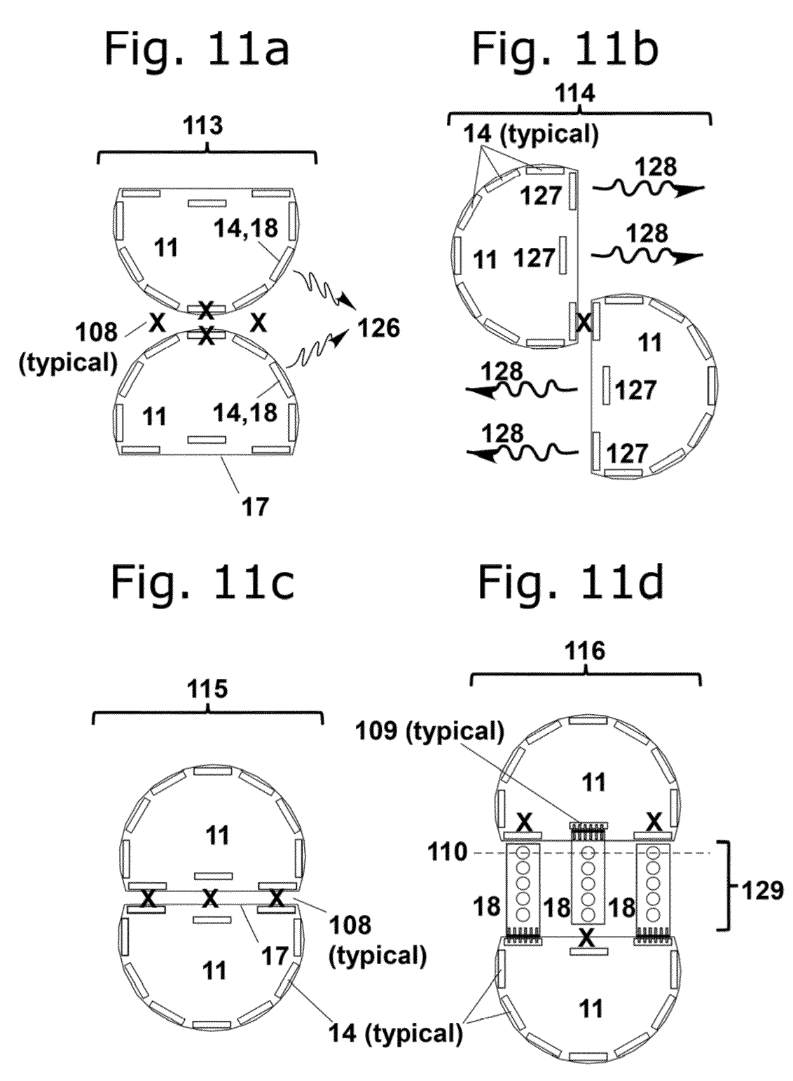

FIG. 11a is an illustration of two fixture bases with the circular areas facing each other, collectively the “XX Hourglass” (113). This predominately surface washing configuration will radiate three parallel shafts north, three south, plus two directly west and two directly east from the corners. The “XX” comes from radiated crossovers (126) off angled-mounted LED shim placements (14, 18), both east and west. The basic fixture base (11) pair arrangement best resembles a common hourglass.

FIG. 11b is an illustration of the straight edges of two fixture bases facing each other where one connector on each base is aligned, collectively forming the “Figure Fighter” (114), which duplicates, mirrors and staggers the “Liberty Crown” illumination pattern (96) shown in FIG. 9. The LED shim placements off the available flat side positions (127) will emit beams (128) that ultimately render a pinwheel-like ‘8’ pattern.

FIG. 11e is an illustration of the straight edges of two fixture bases facing each other, collectively forming the “Oval Rainbow” (115), another surface washing configuration variant like the “Liberty Crown” illumination pattern (96) shown in FIG. 9. Because of tight packing along the fixture bases' (11) fiat sides (17). three ‘X’ exclusion zones (108) are present. The overall illumination spread will yield an oval rainbow.

FIG. 11d is an illustration of the straight edges of two fixture bases facing each other with LED shims attached, collectively forming the “Stretched Column” (116) fixture—a fourth predominately surface washing, variant on the “Liberty Crown” illumination pattern (96) shown in FIG. 9, but with the fixture bases (11) spaced to accommodate a set of LED shims (18) mounted using a 90-degree connector (109). The LED shims' horizontal alignment (110) form an ordered Z-axis LED illumination matrix (129) that shares the electrical load between each fixture base (11). The illumination pattern results in two “Liberty Crown” patterns bridged with a rainbow column.

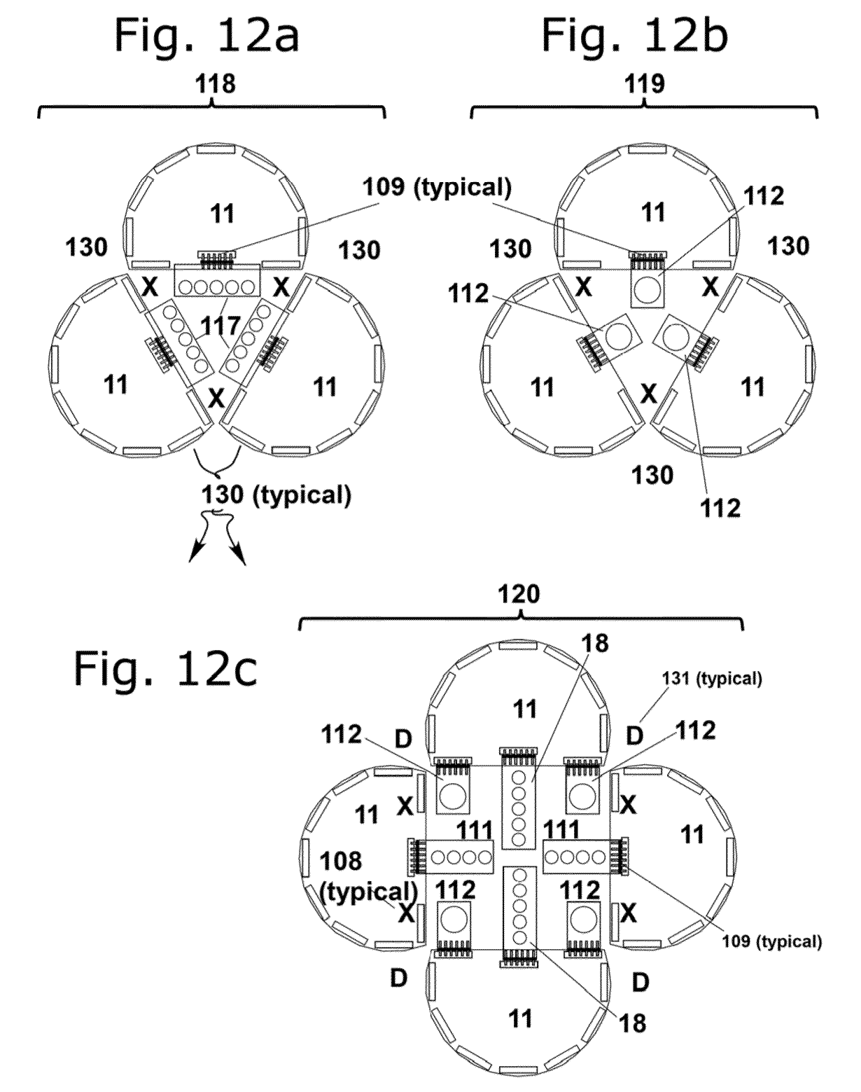

FIG. 12a illustrates three fixture bases aligned to form a triangular radiance pattern, having a multiple LED; right angled shim set shining vertically from center, collectively the “Triangulator 15” (117) fixture, which twice duplicates the FIG. 9 “Liberty Crown” illumination pattern (96) into a triangular arrangement. The triangle center, however, hosts three Longside-connected LED shims (117) using the 90-deg connector (109) yielding 15 center rainbow LEDs arranged as a Z-axis illumination triangle. More interesting are the crossover zones (130) punctuating the triangle points, which will create well-defined splits between the three blended “Liberty Crown” patterns.

FIG. 12b illustrates three fixture bases aligned to form a triangular radiance pattern, having a single high power LED right angle shim set shining vertically front center, collectively the “Triangulator 3” fixture. This configuration resembles the “Triangulator 15” (118) in most respects, except the LED shim variant tripled in the center is a Short. High Bright LED shim (112). This will create a stronger Z-axis illumination center. In their Z-axis illumination respects, both “Triangulator” combinations lend themselves well to a highly decorative ceiling-mounted deployment.

FIG. 12c illustrates four fixture bases aligned to collectively generate a “Full Shamrock” (120), This quadruple combination expands the FIG. 9 “Liberty Crown” into a four-lobed rainbow clover pattern. The high degree of potential pattern overlap makes the junction corners discretionary tones ‘D’ (131) that may or may not be illuminated, depending on the exact pattern desired. The central square formed by the fixture bases' (ii) flat sides can host a variety of LED shim variants all symmetrically mounted using 90-degree connectors (109). Those shown include the Short High Bright LED shim (112), the regular LED shim (18), and a 4-Count LED shim (111), best illustrating the Adaptive LED Lumeniere system's capacity to artfully fill illumination voids.

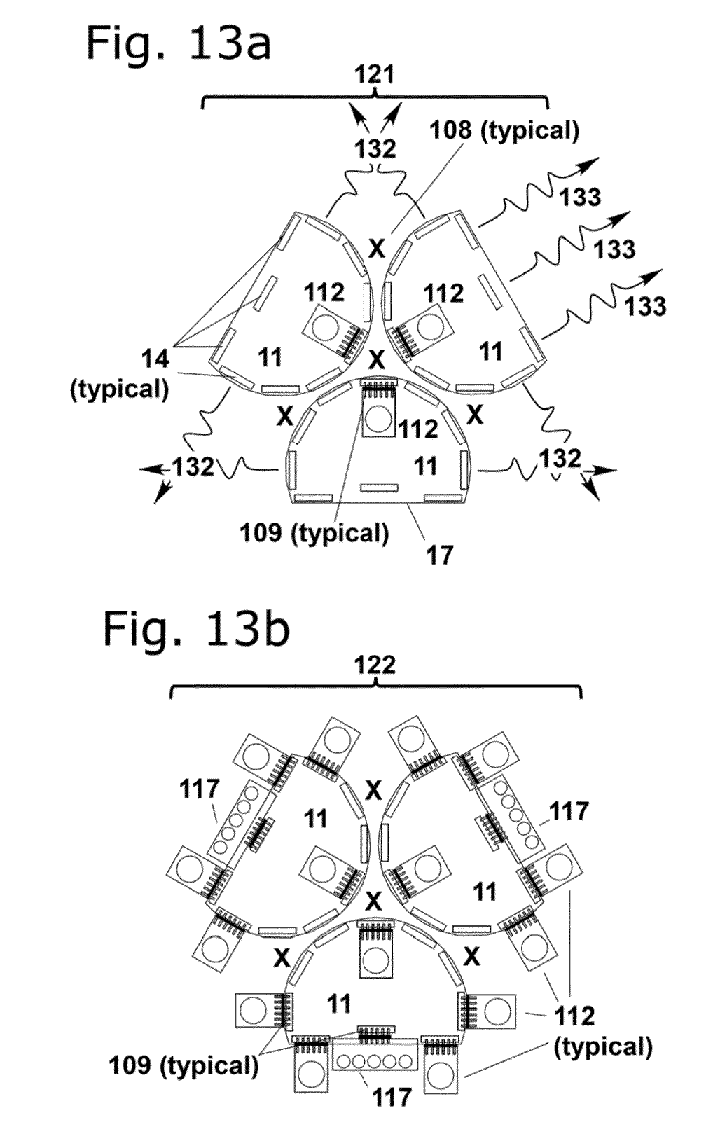

FIG. 13a illustrates three fixture bases aligned as an inverted triangle, with corner crossover optical blending, collectively forming the “Triad Spikes” (121) variant. This “Triangulator” inverse radiates out predominantly from each fixture base's (11) flat side (17) with Short High Bright LED shims (112) in the triangle center. This will form an extending triangle illumination pattern out from the corner crossovers (132), having ‘spikes’ radiating out each side (133). FIG. 13b illustrates three fixture bases aligned and inverted, having a combination multicolor and high power LED right angle shim set radiating out of the fixture base plane, collectively forming the “Triad Plane Fill” (122). This “Triangulator” inverse variant radiates predominately in the Z-axis, as it contains multiple LED shim variants (112, 117) mounted using 90-degree connectors (109). This combination most favors a signage backlighting or high-mount, downshining area illumination application.

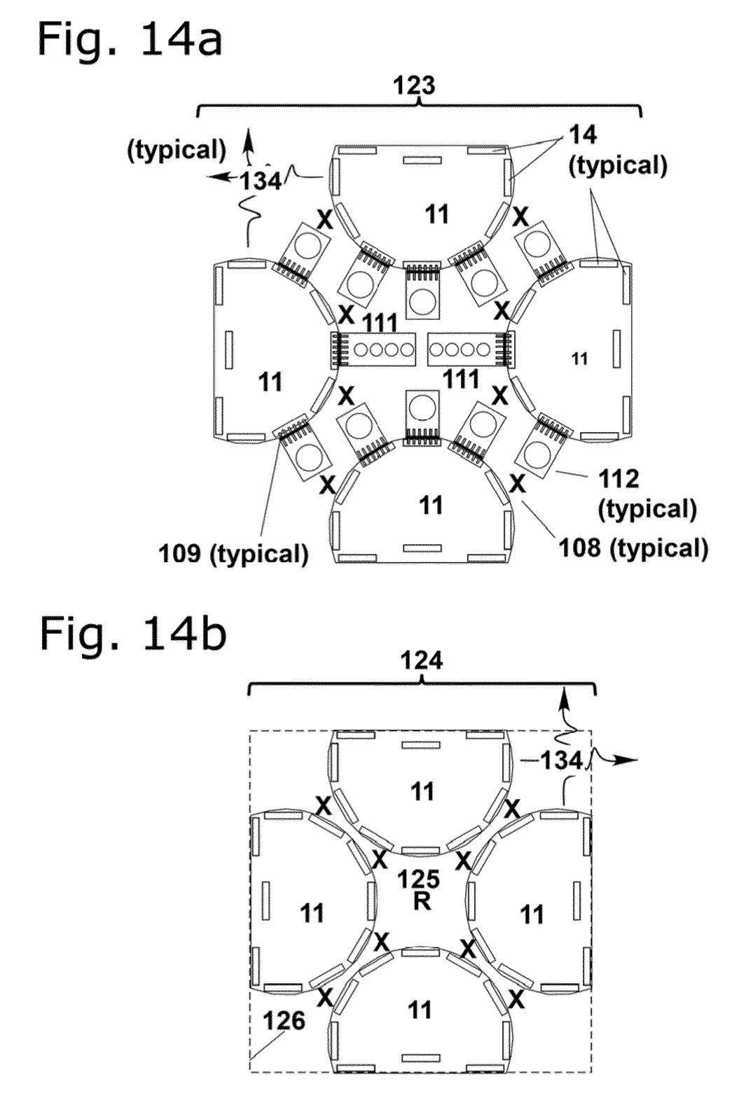

FIG. 14a illustrates four fixture bases aligned to form the “Squared Out” (123) assembly. This “Full Shamrock” (120) inverse radiates as much for surface illumination as in the Z-axis. The surface illumination spread will resemble a four-point star, since the corner crossovers (134) will fill the corner gaps left from the side beams. Of note is the even thermal and electrical load balancing distributed among the four fixture bases (11). The 4-LED shims (111) could he replaced by Short High Bright LED shims (112) for the best load balancing.

FIG. 14b illustrates four fixture bases aligned to radiate to full square cross, having corner crossover optical blending, collectively forming the “Squared In” (124) assembly. This second, tightened “Full Shamrock” (12) inverse resembles the surface output of the “Squared Out” (123) version described above—except for the center filling LED shims. The quad fit here tightly follows the closest square fit (126) afforded by the fixture base (11) geometry. This leaves the center too small for 90-degree mounted shims, but will allow placing vertical LED shims shining into a pyramidal or dome reflector ‘R’ (125).

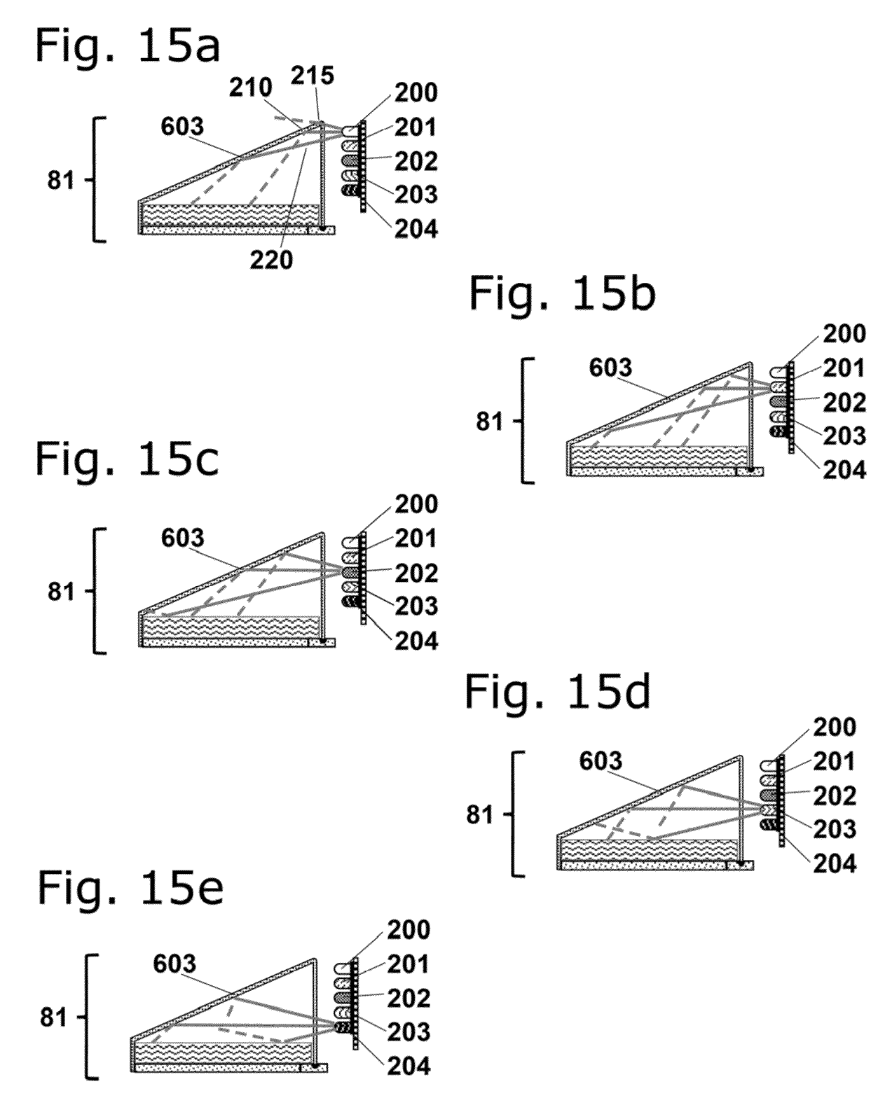

to FIG. 15a illustrates a first LED ray trace through the assembly 81. For illustration purposes five LEDs 200, 201, 202, 203, and 204 are aligned in a vertical direction where 200 is the first LED and 201 is the second and 202 is the third LED, 203 is the fourth LED and 204 is the fifth LED. FIG. 15b illustrates a second. LED 201 ray trace. FIG. 15c illustrates a third LED 202 ray trace. FIG. 15d illustrates a fourth LED 203 ray trace. FIG. 15e illustrates a fifth LED 204 ray trace. The LEDs are aligned with the first leg 602 of the strip wherein the first LED 200 will emit a ray of light which will diffuse by hypotenuse 603 and reflect off of mirror surface 55. Each LED emits at least three rays that will produce a rainbow blended color scheme as the lights transmit and reflect in the TDF. As shown in FIGS. 15a-d, the LEDs transmit and reflect light at different angles in the TDF to a produce color blending effect together. The LEDs emit rays at least in a straight line 210 from the LED, in an upper angled direction 215 and a lower angled direction 220.

The invention has been described in detail with particular reference to certain preferred embodiments thereof, but it will be understood that variations and modifications can be effected within the spirit and scope of the invention.

1. A lighting system comprising:
a. fixture having a semicircular base having a printed circuit assembly, connectors along the base in a semicircular array, wherein the connectors receive illuminating devices positioned to shine outwards;
spokes aligned with the connectors each spoke having a mirror extending along the length of each spoke and a strip mounted over the spoke,
wherein the strip forms a triangular shape over the spoke,
wherein the strip acts as a diffuser,
whereby the illuminating devices mix within the diffuser resulting in color blending.

2. The lighting system of claim 1 wherein the mirror is semicircular.

3. The lighting system of claim 1 wherein the illuminating devices shine outwards at about 30-degree radial increments around the base.

4. The lighting system of claim 1 wherein the spokes further comprise a first end attached to the fixture and a second end opposite the first end.

5. The lighting system of claim 4, wherein the strip features a first leg which extends upwards from the first end to a first point and is then angled to extend towards the second end to a second point to form a hypotenuse

6. The lighting system of claim 5, wherein the strip forms a hermetic seal between the second point and the second end of the strip.

7. The lighting system of claim 1, wherein the illuminating devices are aligned onto the connector such that each device reflects light at a different angle.

8. The lighting system of claim 1, wherein the illuminating devices are through hole LEDs, wherein a heat sink assembly is formed from the illuminating devices electrical connections excess length.

9. A lighting system comprising:
a fixture having a base:
at least one connector along the base, wherein the connector receive illuminating devices;
at least one spoke extending away from the fixture and connected to the fixture by a first end wherein the second end is opposite the first end, wherein the distance between the first end and second end forms a length of the at least one spoke,
wherein the at least one spoke is aligned with the connectors,
wherein the at least one spoke has a reflective device extending along the length and a strip mounted over the spoke, wherein the strip forms a triangular shape over the spoke.

10. The lighting system of claim 9, wherein the connectors are positioned in a semi-circular array around the base.

11. The lighting system of claim 9, wherein lights emitting from the illuminating devices emits outwards at about 30-degree radial increments around the base.

12. The lighting system of claim 9, wherein the strip features a first leg which extends upwards from the first end to a first point and is then angled to extend towards the second end to a second point to form a hypotenuse

13. The lighting system of claim 12, wherein the illuminating devices project light through the first leg and. scatters the light with, the hypotenuse and reflective device to color blend.

14. The lighting system of claim 9, wherein the reflective device is a semicircular pipe with a reflective surface.

15. A method of color blending light comprising:
providing a fixture having a semi-circular base providing a printed circuit assembly on the base,
providing at least one connector along the base, wherein the at least one connector receives illuminating devices linearly positioned on the connector, wherein the at least one connector is positioned in a semi-circular array;
providing at least one spoke aligned with the at least one connector, wherein the at least one spoke comprises a mirror extending along the length of the at least one spoke and a strip mounted over the at least one spoke, wherein the strip forms a triangular shape over the spoke;
emitting light from the illuminating devices through the triangular shape whereby the light mixes using the strip and mirror.
